(19) United States
(12) Patent Application Publication
(10) Pub. No.: US 2018/0188134 A1
(43) Pub. Date: Jul. 5, 2018

(54) METHOD AND SYSTEM FOR DETERMINING THE AERODYNAMIC RESISTANCE OF A CYCLIST

(71) Applicant: APEIRA TECHNOLOGIES, Le Creusot (FR)

(72) Inventors: Matthieu VOIRY, Bois-Colombes (FR); Cédric LEMAITRE, Saint-Julien-sur-Dheune (FR)

(73) Assignee: APEIRA TECHNOLOGIES, Le Creusot (FR)

(21) Appl. No.: 15/743,224

(22) PCT Filed: Jul. 12, 2016
(86) PCT No.: PCT/EP2016/066531

§ 371 Date: Jan. 9, 2018

(30) Foreign Application Priority Data
Jul. 17, 2015 (FR) 1556815

(51) Int. Cl. G01M 9/08; G01C 3/08; G06F 17/50; G06T 17/20

(52) U.S. Cl. CPC G01M 9/08; G01C 3/08; G06F 2217/16; G06T 17/20; G06F 17/5018

(57) ABSTRACT

A method for determining the aerodynamic resistance of an object or a person having its own movement, remarkable in that it includes at least the following steps: acquiring, between two moments tᵢₙᵢₜ and t_{fin} 3D clouds of dots corresponding to the spatial position of various points positioned at different locations of the object or the person; determining 3D models as a function of time, for each moment between tᵢₙᵢₜ and t_{fin}, from dots of the clouds of dots acquired at each moment between the moments tᵢₙᵢₜ and t_{fin}; simulating the movement of the solids described by the clouds of dots corresponding to the object with a person in a fluid, for each moment between the moments tᵢₙᵢₜ and t_{fin}; and calculating the average of the aerodynamic resistance forces exerted on the object or person between the moments tᵢₙᵢₜ and t_{fin}.

### TECHNICAL FIELD

The present invention relates to a method and system for determining the aerodynamic resistance of a moving object and/or person. More particularly, the invention relates to a method and system for determining the aerodynamic resistance of a cyclist. It will also allow him to improve his performance by adapting his position on the bicycle to minimize said aerodynamic resistance.

### BACKGROUND OF THE INVENTION

It is well known that aerodynamic resistance is made up of two forces, namely drag and lift. In cycling, for example, in light of the movement speeds, the lift is considered negligible, such that the aerodynamic resistance is therefore likened to the drag.

In a manner known in itself, the drag is given by the following equation:

R_{A}=0.5pAₚC_{d}V_{f}²

where Ap designates the projected frontal area of the cyclist and his bicycle, Cd is the drag coefficient, ρ is the density of the air and Vf is the flow speed of the fluid on the cyclist's body.

In the context of an aerodynamic study, the quantity that one seeks to minimize is the actual frontal area given by the following equation:

$${A}_{p} {C}_{d} = \frac{{R}_{A}}{0.5 ρ {V}_{f}^{2}}$$

In order to determine the actual frontal area, it is necessary to know the drag R_{A}. It will be noted that the actual frontal area is not a constant, but evolves slightly with the movement speed.

In order to evaluate the actual frontal area of a cyclist, several methods are well known, these various methods being described in the publication by Vincent Chabroux “Approche aérodynamique et biomécanique de l'amélioration des performances de cyclistes en course contre la montre” [Aerodynamic and biomechanical approach to improving cyclists' performance when trying to beat the clock] PhD thesis, Universite de la Mediterranee, 2010 and in the publication by F. Grappe. “Cyclisme et optimisation de la performance: sciences et methodologie de l'entraînement” [Cycling and performance optimization: training science and methodology]. Sciences et pratiques du sport, De Boeck, 2005.

For the most part, these methods can be classified in four groups: mechanical power analysis, towing-based measurement, the deceleration method and wind tunnel measurement.

The analysis of the mechanical power consists of measuring the power delivered by the cyclist owing to a wattmeter at different speeds, then evaluating the drag using a linear regression from said delivered power measurements. This method is relatively precise, but requires several tests under real conditions.

The towing-based measurement consists of measuring the traction forces by towing a cyclist on his bicycle with a car moving at a constant speed. This method is fairly restrictive and lacks precision due to turbulence caused by the towing vehicle.

The deceleration method consists of measuring the deceleration of the cyclist at different speeds. Thus, by using Newton's laws, the drag is calculated. This method is very cumbersome to set up and requires the cyclist to be immobile.

Wind tunnel measurements consist of generating a stream of air over the cyclist/bicycle unit and quantifying the reaction forces on the ground using a force platform. This method, although the most precise, is also the most expensive.

It will be noted that in aerodynamics, it is well known to determine aerodynamic and/or mechanical characteristics, such as the deformation of an object or the drag of an object, for example, using wind tunnel tests. This is in particular the case for documents U.S. Pat. No. 7,997,130 and US 2007/095135.

Document U.S. Pat. No. 7,997,130 describes a system and method for measuring the deformation of an object, such as a fighter aircraft, for example, positioned in the tunnel of a wind tunnel. The object is positioned in the tunnel of a wind tunnel and a system for acquiring a cloud of dots representing at least one surface of the object is recorded. The object is moved in the stream of the tunnel of the wind tunnel and clouds of dots of the surface of the object are also acquired during said movement in order to determine, using a computer system receiving the data relative to the clouds of dots, at least the position of the object, its orientation and the deformation of the surface of the object.

Document US 2007/095135 describes a method for determining the drag of an aircraft comprising providing a model of the aircraft, which is positioned in a tunnel of a wind tunnel in a determined initial orientation, and a plurality of orientation and incline sensors mounted on said model. The model is next moved in the tunnel of the wind tunnel from its initial orientation toward a second orientation in order to determine the drag of the aircraft in the various possible orientations of the latter.

However, aside from the fact that these methods are particularly expensive in light of the need to use a wind tunnel, they are not suitable for determining the aerodynamic resistance of a cyclist in particular.

Recently, a new method for measuring aerodynamic resistance was proposed. This method is in particular described in the publications byT. Defraeye, B. Blocken, E. Koninckx, P. Hespel, and J. Carmeliet. “Aerodynamic study of different cyclist positions: CFD analysis and full-scale wind-tunnel tests.” J Biomech, 43(7):1262-1268, May 2010 and Peter Nicholas Doval. “Aerodynamic Analysis and Drag Coefficient Evaluation of Time-Trial Bicycle Riders.” PhD thesis, University of Wisconsin-Milwaukee, 2012.

This method consists of coupling a 3D model of the cyclist and his bicycle obtained using a scanner with a fluid dynamic digital calculation code. This method makes it possible to obtain aerodynamic drags in accordance with those measured in a wind tunnel. It has the advantage of being done at a lower cost and without needing to use real conditions. However, its main drawback is that it uses a static model that is not representative of a cyclist in the process of pedaling.

### BRIEF DESCRIPTION OF THE INVENTION

One of the aims of the invention is therefore to resolve these drawbacks by providing a method and a system for determining the aerodynamic resistance of a moving object or person having a simple and inexpensive design, allowing contactless measurement of the aerodynamic resistance of an object or a person, such as a moving cyclist, without said object or person moving relative to the ground. A moving person is a person who on the one hand is in motion relative to a fluid, such as the air, and on the other hand, in motion himself, for example a pedaling movement in the case of a cyclist.

To that end and according to the invention, proposed is a method for determining the aerodynamic resistance of an object or a person having its own movement, remarkable in that it includes at least the following steps:
acquiring, between two moments tᵢₙᵢₜ and t_{fin} 3D clouds of dots corresponding to the spatial positions of various points positioned at different locations of the object or the person,
determining 3D models as a function of time, for each moment between tᵢₙᵢₜ and t_{fin}, from dots of the clouds of dots acquired at each moment between the moments tᵢₙᵢₜ and t_{fin},
simulating the movement of the solids described by the clouds of dots corresponding to the object with a person in a fluid, for each moment between the moments tᵢₙᵢₜ and t_{fin},
calculating the average of the aerodynamic resistance forces exerted on the moving object or person between the moments tᵢₙᵢₜ and t_{fin}.

Preferably, said step for acquiring clouds of dots consists of at least the following steps:
projecting a pattern, such as a moiré on the object or person,
acquiring several images of the project a pattern between the moments tᵢₙᵢₜ and t_{fin},
calculating by triangulation and recording the position of dots belonging to the pattern, between moments tᵢₙᵢₜ and t_{fin}.

Furthermore, the step for determining 3D models as a function of time from dots of the clouds of dots acquired at each moment between the moments tᵢₙᵢₜ and t_{fin} consists of at least the following steps:
applying at least one preprocessing operation of the data relative to the recorded sets of clouds of dots,
determining a mesh from the data relative to the recorded and processed sets of clouds of dots.

Said step for preprocessing of the data relative to the recorded sets of dots consists of at least one step for filtering abnormal dots and/or filtering noise and/or spatiotemporal smoothing.

Furthermore, the step for simulating the movement of the solids described by the clouds of dots corresponding to the object with a person in a fluid, for each moment between the moments tᵢₙᵢₜ and t_{fin} consists of at least the following steps:
breaking down, in an orthogonal base (i,j,k), the vector D corresponding to the relative movement of the solid in the fluid as the difference between the vector V corresponding to the characteristic vector of the movement of the fluid in the vector C corresponding to the characteristic vector of the movement of the object or the person,
determining the vector D as a function of C, Vx, Vy and Vz, with C the speed of the object or person considering that the movement of the object or person is done along the axis i, Vx the windspeed along the axis i, Vy the speed of the wind along the axis j and Vz the speed of the wind along the axis k,
determining the probability law joined to the variables C, Vx, Vy and Vz, said variables being considered non-independent random variables, corresponding to the density P(C,Vx,Vy,Vz).

Said average of the aerodynamic resistance forces is determined by calculating the quadruple integral of the product of the density P(C,Vx,Vy,Vz) and the aerodynamic resistance forces exerted on the object or the person F(D(C,Vx,Vy,Vz)).

Advantageously, the average of the aerodynamic resistance forces can be calculated considering that:
the flow of the fluid is parallel to the horizontal plane, i.e., the component Vx is zero,
the strength of the wind V does not depend on its direction, and/or
the speed of the object or person having its own movement does not depend on the strength V of the wind or its direction, and/or
the movement specific to the object or person is symmetrical relative to the axis defined by i, and/or
the clouds of dots are recorded in a time interval equal to the period of the specific movement of the object or the person.

Another object of the invention relates to a system for determining the aerodynamic resistance of an object or a person having its own movement, remarkable in that it includes at least:
means for acquiring, between two moments tᵢₙᵢₜ and t_{fin} 3D clouds of dots corresponding to the spatial position of various points positioned at different locations of the object or the person,
means for determining 3D models as a function of time, for each moment between tᵢₙᵢₜ and t_{fin}, from dots of the clouds of dots acquired at each moment between tᵢₙᵢₜ and t_{fin},
means for simulating the movement of the solids described by the clouds of dots corresponding to the object with a person in a fluid, for each moment between the moments tᵢₙᵢₜ and t_{fin},
means for calculating the average of the aerodynamic resistance forces exerted on the moving object or person between the moments tᵢₙᵢₜ and t_{fin}.

Preferably, said means for acquiring clouds of dots comprise at least:
means for projecting a pattern, such as a moiré on the object or person,
means for acquiring several images of the project a pattern between the moments tᵢₙᵢₜ and t_{fin},
means for calculating by triangulation and recording the position of dots belonging to the pattern, between moments tᵢₙᵢₜ and t_{fin}.

Said means for determining 3D models as a function of time from dots of the clouds of dots acquired at each moment between the moments tᵢₙᵢₜ and t_{fin} comprise at least:
means for preprocessing operation of the data relative to the recorded sets of clouds of dots,
means for determining a mesh from the data relative to the recorded and processed sets of clouds of dots.

Furthermore, the means for preprocessing of the data relative to the recorded sets of dots consist at least of a filter for abnormal dots and/or a filter for noise and/or spatiotemporal smoothing means.

Said means for simulating the movement of the solids formed by the clouds of dots corresponding to the object with a person in a fluid, for each moment between the moments tᵢₙᵢₜ and t_{fin} comprise at least:
means for breaking down, in an orthogonal base (i,j,k), the vector D corresponding to the relative movement of the solid in the fluid as the difference between the vector V corresponding to the characteristic vector of the movement of the fluid in the vector C corresponding to the characteristic vector of the movement of the object or the person,
means for determining the vector D as a function of C, Vx, Vy and Vz, with C the speed of the object or person considering that the movement of the object or person is done along the axis i, Vx the windspeed along the axis i, Vy the speed of the wind along the axis j and Vz the speed of the wind along the axis k,
means for determining the probability law joined to the variables C, Vx, Vy and Vz, said variables being considered non-independent random variables, corresponding to the density P(C,Vx,Vy,Vz).

Said average of the aerodynamic resistance forces is determined by calculating the quadruple integral of the product of the density P(C,Vx,Vy,Vz) and the aerodynamic resistance forces exerted on the object or the person F(D(C,Vx,Vy,Vz)).

The function F is obtained by digital simulation. This digital simulation consists of simulating a flow of air around the moving object, the direction of which is defined by the parameter D. This simulation thus allows a virtual measurement of the aerodynamic resistance forces exerted on the moving object. Said digital simulation is based on the Navier-Stokes equations. For better results, said simulation may use the Reynolds-Averaged Navier-Stokes (RANS) equations, and more specifically the SST (Shear-Stress Transport) model, described in Menter, F. R. (August 1994), “Two-Equation Eddy-Viscosity Turbulence Models for Engineering Applications”, AIAA Journal 32 (8): 1598-1605.

Furthermore, the average of the aerodynamic resistance forces can be calculated considering that:
the flow of the fluid is parallel to the horizontal plane, i.e., the component Vx is zero, and/or
the strength of the wind V does not depend on its direction, and/or
the speed of the object or person having its own movement does not depend on the strength V of the wind or its direction, and/or
the movement specific to the object or person is symmetrical relative to the axis defined by i, and/or
the clouds of dots are recorded in a time interval equal to the period of the specific movement of the object or the person.

### BRIEF DESCRIPTION OF THE DRAWINGS

Other advantages and features will better emerge from the following description of several alternative embodiments, provided as non-limiting examples, of the method for determining the aerodynamic resistance of a moving object or person according to the invention, from the appended drawings, in which:

FIG. 1 is a schematic illustration of the different steps of the method according to the invention,

FIG. 2 is a schematic illustration of a system for acquiring 3D clouds of dots corresponding to the position of dots on the surface of the moving solid to carry out the method according to the invention.

### DETAILED DESCRIPTION OF THE INVENTION

Below, we will describe a method and a system for determining the aerodynamic resistance of a cyclist pedaling on a bicycle, said cyclist having a specific movement, i.e., his pedaling movement. However, the method and system may of course be adapted to any object or person having its own movement without going beyond the scope of the invention.

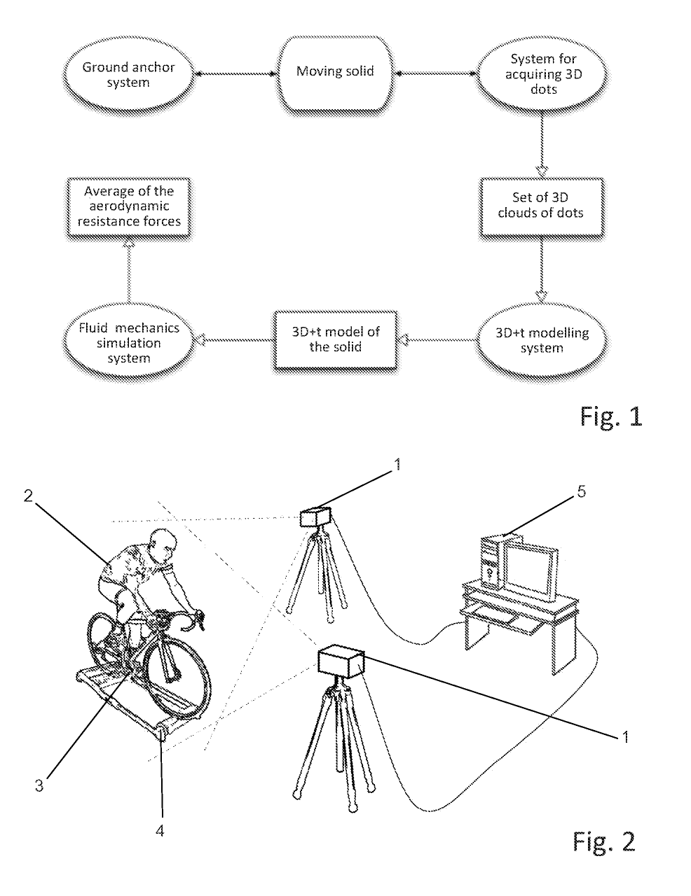

In reference to FIG. 1, the system according to the invention making it possible to measure, without contact and without movement, the aerodynamic resistance of a moving solid includes several interacting sub-systems. More particularly, it includes a system making it possible to study the movement of the solid without the latter moving relative to the ground. Thus, according to the invention, the measurement of the aerodynamics does not require an actual movement of the studied solid relative to the ground. Furthermore, this measurement accounts for the dynamic aspect of the movement of the solid. It is therefore necessary to place the solid under conditions allowing movement without stress, but without any displacement relative to the ground. In the specific application of the determination of the aerodynamic resistance of a cyclist pedaling on a bicycle, said system for example consists of a home trainer with wheels or the like.

Furthermore, the invention also includes a system making it possible to measure, over time, 3D clouds of dots corresponding to the position of dots on the surface of the moving solid, a system making it possible to obtain a correct 3D+t model of the moving solid of interest and a system making it possible to simulate the displacement of the moving solid in a fluid and to measure the forces exerted on this solid.

Said system making it possible to measure, over time, 3D clouds of dots corresponding to the position of dots on the surface of the moving solid is made up of a set of traditional contactless 3D sensors such as time-of-flight cameras, stereoscopic cameras, pattern projection cameras, or the like, placed wisely so as to obtain a set of 3D points completely describing the solid, in the case at hand the cyclist, studied at a time t. This system is capable of acquiring 3D clouds of dots at a pace compatible with the dynamics of the studied movement. One thus obtains a set of 3D clouds of dots representing the solid at different times t.

In reference to FIG. 2, said system making it possible to measure, over time, 3D clouds of dots corresponding to the position of dots on the surface of the moving solid is for example made up of cameras 1 projecting patterns on a cyclist 2 pedaling a bicycle 3 positioned on a home trainer with wheels 4. Said cameras 1 also include CCD sensors able to record the patterns projected by the cameras and reflected by the cyclist 2. These cameras 1 are connected to a processing unit 5, which for example consists of a desktop computer, called a PC, or the like, in which the data corresponding to the clouds of dots is recorded, then processed by a computer program executing the various steps of the system according to the invention.

Said system making it possible to obtain an accurate 3D+t model of the moving solid makes it possible to process all of the 3D clouds of dots in order to obtain a 3D+t model of the moving solid. To that end, a set of preprocessing operations is applied to these clouds of dots: filtering for abnormal dots, filtering for noise, spatiotemporal smoothing, etc. Lastly, a meshing operation is applied in order to obtain a 3D+t model usable by the fluid mechanics simulation system.

The system making it possible to simulate the displacement of the moving solid in a fluid and to measure the forces exerted on the cyclist implements traditional digital fluid mechanics methods in order to simulate the displacement of the studied solid in a fluid (air in the case of the cyclist). This simulation is in particular configured by the direction and displacement speed of the fluid relative to the solid, represented by the vector D. It makes it possible in fine to calculate the average F(D) of the aerodynamic resistance forces exerted on the solid throughout the entire movement sequence recorded by the sensors.

Inasmuch as one seeks to study the aerodynamics under real conditions (for example those of outdoor cycling practice), it is important to account for the fact that the relative speed of the solid with respect to the fluid may change over time. To that end, the method according to the invention proposes to model the different variables of the movement by probability laws making it possible to describe a given environment (for example, a particular cycling journey).

To that end, the space is provided with an orthonormal base (i;j;k) such that the studied solid is displaced along the axis defined by i and the ground is parallel to the plane defined by i and j, for example.

The vector D, relative displacement of the solid in the fluid, can then be broken down as follows:

\vec{D}=\vec{V}−\vec{C}

where V designates the characteristic vector of the wind and C designates the characteristic vector of the movement of the cyclist.

It is next possible to describe:

\vec{D}=Vₓ\vec{i}+V_{y}\vec{j}+V_{z}\vec{k}−C\vec{i}

\vec{D}=(Vₓ−C)\vec{i}+V_{y}\vec{j}+V_{z}\vec{k}

It is therefore possible to write D as a function of C, Vx, Vy and Vz, where C designates the speed of the solid, Vx designates the speed of the wind along the axis i, Vy designates the speed of the wind along the axis j, and Vz designates the speed of the wind along the axis k.

The variables C, Vx, Vy and Vz are next considered to be non-independent random variables whereof the joint probability law is given by the density P(C; Vx; Vy; Vz), this probability law enabling a statistical description of the specific studied environment.

Considering on the one hand that the kinetics of the studied movement are very fast relative to the changes in conditions (i.e., an evolution of the variables C, Vx, Vy and Vz) and on the other hand that the movement sequence is not influenced by the variables C, Vx, Vy and Vz, it is then possible to calculate an average Fₘ of the aerodynamic resistance forces F exerted on the solid in the studied environment as follows:

Fₘ=∫∫∫∫P(C,Vₓ,V_{y},V_{z})F(C,Vₓ,V_{y},V_{z}))dCdVₓdV_{y}dV_{z}

F is obtained by digital simulation. This digital simulation consists of simulating a flow of air around the moving object, the direction of which is defined by the parameter D. This simulation thus allows a virtual measurement of the aerodynamic resistance forces exerted on the moving object. Said digital simulation is based on the Navier-Stokes equations. For better results, said simulation may use the Reynolds-Averaged Navier-Stokes (RANS) equations, and more specifically the SST (Shear-Stress Transport) model, described in Menter, F. R. (August 1994), “Two-Equation Eddy-Viscosity Turbulence Models for Engineering Applications”, AIAA Journal 32 (8): 1598-1605.

It is clear that the virtual measurement of the aerodynamic resistance forces may be done using any other method well known by those skilled in the art, in particular from a direct calculation as a function of the measurements making it possible to determine the 3D model of the moving object, without going beyond the scope of the invention.

The model is simulated by using a digital method (finite elements method, finite volumes method, finite differences method, spectral method, etc.) carried out on a computer.

In order to make the model previously described more easily usable by a computer, the latter is advantageously discretized and simplified.

In the specific case of studying the aerodynamics of a cyclist, the following simplifications can be made:

### Wind Parallel to the Route

It may be considered that the wind is parallel to the route, i.e.:

V_{z}=0

### Independent Direction and Strength of the Wind

Vx and Vy may be expressed as a function of the strength V of the wind and the angle of the wind relative to the axis defined by i:

Vₓ=V cos α

V_{y}=V sin α

It may be considered that the strength V of the wind does not depend on its direction a and vice versa

### Independent Speed of the Cyclist and Wind

It may be considered that the speed C of the cyclist does not depend on the strength V of the wind or its direction a.

Thus, by using the three previous simplifications, the joint probability law can be rewritten in the following simplified form:

P(C,Vₓ,V_{y},V_{z})=P_{C}(C)P_{V}(V)P_{α}(α)

The independence of the random variables makes it possible to express the joint law as the product of the marginal laws associated with each of them. These laws can be defined much more simply than the joint law. For example, P_{V} is traditionally defined as the probability density associated with a Weibull law; P_{α} is defined as the probability density associated with a uniform law; and P_{C} has a profile specifically depending on the type of studied cyclist event (sprint, stage race, etc.).

It is therefore possible to rewrite the function F, corresponding to the aerodynamic resistance forces exerted on the solid in the studied environment, in the following form:

F(\vec{D})=F(\vec{D}(C,Vₓ,V_{y},V_{z}))

And in light of the simplifications, we can write:

F(\vec{D}(C,Vₓ,V_{y},V_{z}))=F(\vec{D}(C,V cos α,V sin α,0))=F(C,V,α)

In order to limit the number of simulations and discretize the model, it may be considered that the cyclist and his movement are symmetrical relative to the axis defined by i. One then has:

F(\vec{D}(C,V,α))=F(\vec{D}(C,V,−α))

Thus, one may settle for varying a from 0 to it during simulations.

Furthermore, one may also consider that the movement of the cyclist is periodic (with a time period of one pedal revolution). One may therefore settle for recording a movement sequence with a duration equal to this period.

To discretize the model, one first chooses Cₘₐₓ and Vₘₐₓ on the one hand and S_{C}, S_{V} and S_{α} on the other hand such that S_{C} divides Cₘₐₓ, S_{V} divides Vₘₐₓ and S_{α}=2π/k with k an integer.

One then has:

$${n}_{C} = \frac{{C}_{max}}{{S}_{C}}$$

$${n}_{V} = \frac{{V}_{max}}{{S}_{V}}$$

$${n}_{α} = \frac{π}{{S}_{α}}$$

It is then possible to approximate Fₘ as follows:

$${F}_{m} = 2 {\sum }_{i = 1}^{{n}_{C}} {\sum }_{j = 1}^{{n}_{V}} {\sum }_{h = 1}^{{n}_{α}} {\int }_{( i - 1 ) {S}_{c}}^{{iS}_{C}} {P}_{C} ( x ) dx {\int }_{( j - 1 ) {S}_{V}}^{{jS}_{V}} {P}_{V} ( y ) dy {\int }_{( k - 1 ) {S}_{α}}^{{kS}_{α}} {P}_{α} ( z ) dzF ( i , j , k )$$

$$with$$

$$F ( i , j , k ) = F ( \vec{D} ( ( i - \frac{1}{2} ) {S}_{C} , ( j - \frac{1}{2} ) {S}_{V} , ( k - \frac{1}{2} ) {S}_{α} )$$

In this way, the model only requires n=n_{C}n_{V}n_{α} simulations.

Lastly, the examples given above are of course only specific illustrations that are in no case limiting regarding the fields of application of the invention.

1. A method for determining the aerodynamic resistance of an object or a person having its own movement, comprising the steps of:
acquiring, between two moments tᵢₙᵢₜ and t_{fin} 3D clouds of dots corresponding to the spatial positions of various points positioned at different locations of the object or the person;
determining 3D models as a function of time, for each moment between tᵢₙᵢₜ and t_{fin}, from dots of the clouds of dots acquired at each moment between the moments tᵢₙᵢₜ and t_{fin};
simulating the movement of the solids described by the clouds of dots corresponding to the object with a person in a fluid, for each moment between the moments tᵢₙᵢₜ and t_{fin}; and
calculating the average of the aerodynamic resistance forces exerted on the object or person between the moments tᵢₙᵢₜ and t_{fin}.

2. The method according to claim 1, wherein said step of acquiring clouds of dots includes at least the following steps:
projecting a pattern on the object or person;
acquiring several images of the project a pattern between the moments tᵢₙᵢₜ and t_{fin}; and
calculating by triangulation and recording the position of dots belonging to the pattern, between moments tᵢₙᵢₜ and t_{fin}.

3. The method according to claim 1, wherein the step of determining 3D models as a function of time from dots of the clouds of dots acquired at each moment between the moments tᵢₙᵢₜ and t_{fin} includes at least the following steps:
applying at least one preprocessing operation of the data relative to the recorded sets of clouds of dots; and
determining a mesh from the data relative to the recorded and processed sets of clouds of dots.

4. The method according to claim 3, wherein said step of preprocessing of the data relative to the recorded sets of dots includes at least one step for filtering abnormal dots and/or filtering noise and/or spatiotemporal smoothing.

5. The method according to claim 1, wherein the step of simulating the movement of the solids described by the clouds of dots corresponding to the object with a person in a fluid, for each moment between the moments tᵢₙᵢₜ and t_{fin} includes at least the following steps:
breaking down, in an orthogonal base (i,j,k), the vector D corresponding to the relative movement of the solid in the fluid as the difference between the vector V corresponding to the characteristic vector of the movement of the fluid in the vector C corresponding to the characteristic vector of the movement of the object or the person;
determining the vector D as a function of C, Vx, Vy and Vz, wherein C is the speed of the object or person considering that the movement of the object or person is done along the axis i, Vx is the windspeed along the axis i, Vy is the speed of the wind along the axis j and Vz is the speed of the wind along the axis k; and
determining the probability law joined to the variables C, Vx, Vy and Vz, said variables being considered non-independent random variables, corresponding to the density P(C,Vx,Vy,Vz).

6. The method according to claim 1, wherein said average of the aerodynamic resistance forces is determined by calculating the quadruple integral of the product of the density P(C,Vx,Vy,Vz) and the aerodynamic resistance forces exerted on the object or the person F(D(C,Vx,Vy,Vz)).

7. The method according to claim 6, wherein the aerodynamic resistance forces F(D(C,Vx,Vy,Vz)) are determined by digital simulation using the Navier-Stokes equations and/or the Reynolds-Averaged Navier-Stokes (RANS) equations.

8. The method according to claim 5, wherein the average of the aerodynamic resistance forces is calculated while considering that the flow of the fluid is parallel to the horizontal plane.

9. The method according to claim 5, wherein the average of the aerodynamic resistance forces is calculated while considering that the strength of the wind V does not depend on its direction.

10. The method according to claim 5, wherein the average of the aerodynamic resistance forces is calculated while considering that the speed of the object or person with its own movement does not depend on the strength V of the wind or its direction.

11. The method according to claim 5, wherein the average of the aerodynamic resistance forces is calculated while considering that the specific movement of the object or the person is symmetrical relative to the axis defined by i.

12. The method according to claim 5, wherein the average of the aerodynamic resistance forces is calculated while considering that the clouds of dots recorded in a time interval tᵢₙᵢₜ and t_{fin} equal to the period of the specific movement of the object or the person.

13. A system for determining the aerodynamic resistance of an object or a person having its own movement, comprising:
means for acquiring, between two moments tᵢₙᵢₜ and t_{fin} 3D clouds of dots corresponding to the spatial position of various points positioned at different locations of the object or the person;
means for determining 3D models as a function of time, for each moment between tᵢₙᵢₜ and t_{fin}, from dots of the clouds of dots acquired at each moment between tᵢₙᵢₜ and t_{fin};
means for simulating the movement of the solids formed by the clouds of dots corresponding to the object with a person in a fluid, for each moment between the moments tᵢₙᵢₜ and t_{fin}; and
means for calculating the average of the aerodynamic resistance forces exerted on the moving object or person between the moments tᵢₙᵢₜ and t_{fin}.

14. The system according to claim 13, wherein the means for acquiring clouds of dots comprise at least:
means for projecting a pattern, such as a moiré on the object or person;
means for acquiring several images of the project a pattern between the moments tᵢₙᵢₜ and t_{fin}; and
means for calculating by triangulation and recording the position of dots belonging to the pattern, between moments tᵢₙᵢₜ and t_{fin}.

15. The system according to claim 13, wherein said means for determining 3D models as a function of time from dots of the clouds of dots acquired at each moment between the moments tᵢₙᵢₜ and t_{fin} comprise at least:
means for preprocessing operation of the data relative to the recorded sets of clouds of dots; and
means for determining a mesh from the data relative to the recorded and processed sets of clouds of dots.

16. The system according to claim 15, wherein the means for preprocessing of the data relative to the recorded sets of dots includes at least a filter for abnormal dots and/or a filter for noise and/or spatiotemporal smoothing means.

17. The system according to claim 13, wherein said means for simulating the movement of the solids formed by the clouds of dots corresponding to the object with a person in a fluid, for each moment between the moments tᵢₙᵢₜ and t_{fin} comprise at least:
means for breaking down, in an orthogonal base (i,j,k), the vector D corresponding to the relative movement of the solid in the fluid as the difference between the vector V corresponding to the characteristic vector of the movement of the fluid in the vector C corresponding to the characteristic vector of the movement of the object or the person;
means for determining the vector D as a function of C, Vx, Vy and Vz, wherein C is the speed of the object or person considering that the movement of the object or person is done along the axis i, Vx is the windspeed along the axis i, Vy is the speed of the wind along the axis j and Vz is the speed of the wind along the axis k; and
means for determining the probability law joined to the variables C, Vx, Vy and Vz, said variables being considered non-independent random variables, corresponding to the density P(C,Vx,Vy,Vz).

18. The system according to claim 13, wherein said average of the aerodynamic resistance forces is determined by calculating the quadruple integral of the product of the density P(C,Vx,Vy,Vz) and the aerodynamic resistance forces exerted on the object or the person F(D(C,Vx,Vy,Vz)).

19. The system according to claim 18, wherein the aerodynamic resistance forces F(D(C,Vx,Vy,Vz)) are determined by digital simulation using the Navier-Stokes equations and/or the Reynolds-Averaged Navier-Stokes (RANS) equations.

20. The system according to claim 17, wherein the average Fₘ of the aerodynamic resistance forces is calculated while considering that the flow of the fluid is parallel to the horizontal plane.

21. The system according to claim 17, wherein the average Fₘ of the aerodynamic resistance forces is calculated while considering that the strength of the wind V does not depend on its direction.

22. The system according to claim 17, wherein the average Fₘ of the aerodynamic resistance forces is calculated while considering that the speed of the moving object or person does not depend on the strength V of the wind or its direction.

23. The system according to claim 17, wherein the average Fₘ of the aerodynamic resistance forces is calculated while considering that the specific movement of the object or the person is symmetrical relative to the axis defined by i.

24. The system according to claim 17, wherein the average Fₘ of the aerodynamic resistance forces is calculated while considering that the clouds of dots recorded in a time interval tᵢₙᵢₜ and t_{fin} equal to the period of the specific movement of the object or the person.

25. An application of the method according to claim 1 to the determination of the aerodynamic resistance of a cyclist having his own pedaling movement on a bicycle.
